(19) United States
(12) Patent Application Publication
(10) Pub. No.: US 2022/0001713 A1
(43) Pub. Date: Jan. 6, 2022

(54) MOBILE WORKING MACHINE AND METHOD FOR STABLE OPERATION OF SAME

(71) Applicant: HYDAC SYSTEMS & SERVICES GMBH, Sulzbach/Saar (DE)

(72) Inventors: Heinz-Peter HUTH, Ueberherrn (DE); Marc ANTON, Voelklingen (DE)

(21) Appl. No.: 16/479,665

(22) PCT Filed: Jan. 12, 2018
(86) PCT No.: PCT/EP2018/050763

§ 371 Date: Jul. 22, 2019

(30) Foreign Application Priority Data
Feb. 8, 2017 (DE) 10 2017 001 138.9

(51) Int. Cl. B60G 17/0165; A01B 63/10; B60G 11/26; B60G 17/015; B60G 11/30

(52) U.S. Cl. CPC B60G 17/0165; A01B 63/10; B60G 11/265; B60G 2202/414; B60G 11/30; B60G 2206/0116; B60G 17/0152

(57) ABSTRACT

A mobile working machine, in particular an agricultural device such as a self-propelled sprayer, comprising a structure which is hydraulically supported with respect to an undercarriage by means of cylinders (2, 4) having a piston chamber (6) and a rod chamber (8), wherein a switching device (18, 22, 36, 38) is provided which, in a switching position, fluidically connects the piston chamber (6) of a cylinder (2, 4) to the rod chamber (8) of another cylinder (2, 4), and vice versa, characterised in that, as part of the switching device, first valves (18, 22) and second valves (36, 38) are connected on the fluid-conveying connection (12, 14) between the piston chamber (6) of the one cylinder (2, 4) and the rod chamber (8) of the other cylinder (2, 4), the first valves (18, 22) each being connected on the input side to the piston chamber (6) and to a first hydraulic accumulator (28, 30) and the second valves (36, 38) being connected on the input side to the rod chamber (8) and on the output side to a second hydraulic accumulator (32, 34).

The invention concerns a mobile machine, in particular an agricultural machine such as a self-propelled spray unit, comprising a structure that is hydraulically supported with respect to an undercarriage by means of cylinders that are provided with a piston chamber and a rod chamber, wherein a switching device is provided that connects, in one switch position, the piston chamber of one cylinder with the rod chamber of another cylinder and vice versa in a fluid-conducting manner. Moreover, the invention concerns a method for the stable operation of such a machine.

Machinery of this kind is prior art (see EP 1 686 045 B1) and is mainly used in agriculture in form of self-propelled units. The cylinders, which are cross-connected in a fluid-conducting manner, form a hydropneumatic suspension system. In order to meet the requirements of mechanized agricultural engineering, machinery of this kind also has a system for level control and/or roll stabilization. The hydraulic cylinders that are connected by way of the switching device thus form also part of these systems. Said state of the art systems are provided with displacement sensors for piston position, inclinometers to detect the tilt angle of the structure and, if required, further sensors for operating parameters such as travel speed, acceleration, steering angle as well as load and ground conditions. A controller, which processes said signals, operates level control valves, which are assigned to the hydraulic cylinders in addition to the switching device mentioned at the outset.

Based upon said prior the art it is the object of the invention to provide a machine of the kind described at the outset, which is characterized by particularly reliable travelling characteristics on varying ground conditions.

Said object is met according to the invention by a machine that bears the characteristics of claim 1 in its entirety.

According to the characterizing part of claim 1 a significant feature of the invention is that first and second valves are connected to the respective fluid connections between the piston chamber of the one cylinder and the rod chamber of the other cylinder as part of the switching device, wherein said first valves are each connected to the inlet side of the piston chamber and to a first hydraulic accumulator each, and the said second valves are each connected to the inlet side of the rod chamber and at the outlet side to a second hydraulic accumulator each. Compared to the described, known solution, this design of the switching device opens up an increased number of possibilities for the reciprocal connection of piston chamber and rod chamber of the cylinders as well as the option of connecting the rod chambers with their own hydraulic accumulators. The machine according to the invention can therefore be much better adapted to different travelling conditions and terrains.

The first valves and the second valves may advantageously be formed by 2/2-way switching valves.

An electromagnetic operation of the valves is preferable so that they can be controlled directly through the signal processing controller.

The arrangement may advantageously be such that the valves are mechanically preloaded into the closed position. Since all valves are thus in a defined state in case of failure of the electrical system, a fail-safe function is ensured.

The rod chamber of the cylinders may be connected to a suction device that is provided with a non-return valve which blocks in the direction of a tank that stores fluid. If, despite the blocked fluid connection, the cylinder retracts, cavitation in the rod chamber through suction is avoided.

Another object of the invention is also a method for the stable operation of a mobile machine according to one of the claims 1 to 6, which is provided with a roll stabilizing system, wherein the method has the characteristics stated in claim 7. In accordance with this the method provides that, depending on travelling tasks as well as the signals generated by the roll stabilizer, which represent the state of loading of the cylinders, the first and the second valves are operated in groups each into a switch position that is the same for the respective group.

This may be implemented in that the valve operation is based upon the terrain-dependent travelling tasks of the machine.

In this respect, when travelling on a field compared to travelling on the road, a softer suspension can be provided by the cylinders in that the valves of the first group and the valves of the second group are all switched into the open state. In this switching position the piston chambers are connected to a first and a second hydraulic accumulator and are also interconnected between each other. The same applies for the rod chambers, which are also interconnected between each other as well as to a first and a second hydraulic accumulator, so that a desired soft suspension is provided for field travel.

For travelling on a slope, the valve group that is assigned to the cylinders of the downhill wheels may be actuated into the open position, and the valves of the other group into the closed position. This switch position causes a stiffening of the retracting movement of the cylinders so that the load shift to the downhill cylinders caused by a slope position does not lead to a retraction but to an increased support of the downhill wheels.

When travelling on a steep slope the valves of all groups, that is, also the valves of the cylinders that are assigned to the uphill wheels, are switched into the closed position so that even in the instance of an extreme load shift towards the downhill wheels there will be no unduly great strut compression and overturning of the machine on a steep slope is avoided.

The invention will now be described in detail by way of the attached drawing. Shown are in:

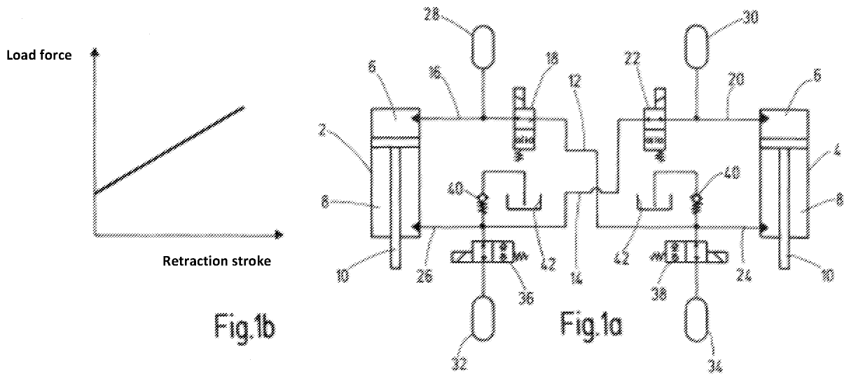

FIG. 1a in symbolic representation the hydraulic circuit of the hydropneumatic axle suspension of an exemplary embodiment of the machine according to the invention, showing a soft spring characteristic;

FIG. 1b a diagram of the spring characteristic in the switch position of FIG. 1a;

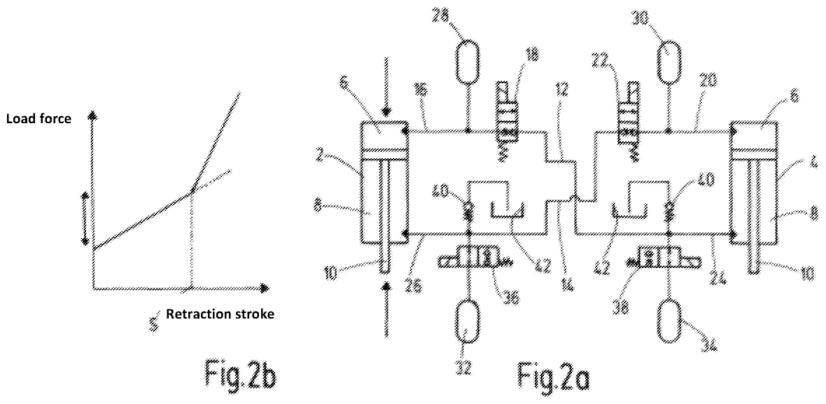

FIG. 2a the hydraulic circuit of FIG. 1a in which the switch position with a harder spring characteristic is depicted;

FIG. 2b the diagram of the spring characteristic in the switch position of FIG. 2a;

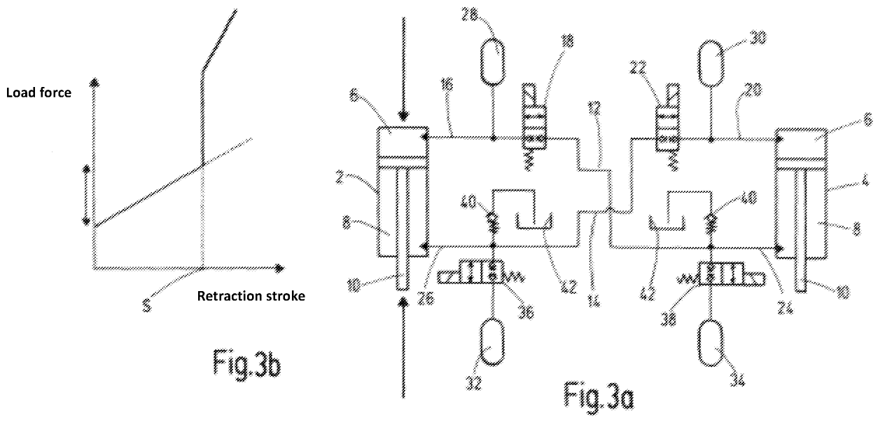

FIG. 3a the hydraulic circuit of FIG. 1a in which the switch position with a hard spring characteristic is depicted; and

FIG. 3b the diagram of the spring characteristic in the switch position of FIG. 3a.

The FIGS. 1a, 2a and 3a depict of the axle suspension of an otherwise not depicted mobile machine, such as a self-propelled spray unit for agricultural use, only the hydropneumatic suspension of one axle. Hydraulic cylinders 2 and 4 are provided as spring cylinders, each of which has a piston chamber 6 and a rod chamber 8, and which are connected with their piston rod 10 to an associated wheel suspension (not shown). The piston chamber 6 of the first cylinder 2 may be connected with the rod chamber 8 of the second cylinder 4 via a fluid-conducting fluid connection 12 in a so-called cross-connection circuit, and the piston chamber 6 of the second cylinder 4 may be connected via a second fluid-conducting connection 14 with the rod chamber 8 of the first cylinder 2.

A switching valve 18 is connected at the inlet side via a pipe section 16 to the piston chamber 6 of the first cylinder 2, and a switching valve 22 is connected at the inlet side via a pipe section 20 to the piston chamber 6 of the second cylinder 4. The switching valve 18 is connected via a pipe section 24 to the rod chamber 8 of the second cylinder 4, and the switching valve 22 is connected via a pipe section 26 to the rod chamber 8 of the first cylinder 2. By means of said switching valves, which are in this instance identified by the numbers 18 and 22 and are formed through 2/2-way switching valves, the fluid-conducting connection 12 and 14 that forms the cross-connection may either be opened or closed. The first valves 18 and 22 may be operated electromechanically and are mechanically preloaded into the closed position.

A hydropneumatic accumulator 28 and 30 respectively is each assigned to the piston chamber 6 of first cylinder 2 and second cylinder 4, of which the accumulator 28 is connected with its oil side via the pipe section 16 to the piston chamber 6 of the first accumulator 28, and the second accumulator 30 is connected with its oil side via the pipe section 20 to the piston chamber 6 of the second cylinder 4. A hydropneumatic third and hydropneumatic fourth accumulator 32 and 34 respectively is also assigned each to the rod chamber 8 of the cylinders 2 and 4, of which the accumulator 32 is connected with its oil side via a switching valve 36 to the pipe section 26, which leads to the rod side 8 of cylinder 2, and the oil side of the fourth accumulator 34 is connected via a switching valve 38 and the pipe section 24 to the rod chamber 8 of the second cylinder 4. The switching valves 36 and 38 which, like the first switching valves 18 and 22, are formed by 2/2-way switching valves, may also be operated electromechanically and are mechanically preloaded into the closed position. The switching valves 36 and 38 are in this instance designated as second valves 36, 38. Moreover, connected to the pipe sections 24 and 26 each is a suction device, wherein each of them is provided with a non-return valve 40 that closes in the direction of a fluid tank 42.

FIG. 1a depicts an operating state in which the first valves 18 and 22 are switched into the open state so that the cross-connection circuit with the fluid-conducting connections 12 and 14 is open. In this state the second switching valves 36, 38 are also switched into the open position so that not only the first and second accumulator 28 and 30 are connected to the fluid-conducting connections 12 and 14 but also the third and fourth accumulator 32 and 34. Thus the entire accumulator volume is available for the piston chambers 6 and the rod chambers 8 of both cylinders 2 and 4 so that load-dependent retraction movements on cylinders 2, 4 take place with a soft characteristic. For the machine this means a travelling characteristic suitable for driving in a field with soft suspension and with terrain-dependent levelling control by way of roll stabilization. The corresponding spring characteristic has a sloped, linear trend, as shown in FIG. 1b.

Travelling on a slope causes a load shift to the suspension cylinders assigned to the downhill wheels which, with a soft spring characteristic for travel on a field, causes therefore an undesired cylinder retraction movement that increases the tilt angle. As the roll stabilization system sensors recognize a correspondingly large load shift, the first switching valves 18 and 22, as shown in FIG. 2a, are switched into the closed position due to a signal supplied by said roll stabilization system so that the cross-connection circuit with connections 12 and 14 is closed. In this operating state, shown in FIG. 2a, the connection between first accumulator 28 and rod chamber 8 of cylinder 4 as well as the connection between second accumulator 30 and rod chamber 8 of the first cylinder 2 are shut off. On from the switching point indicated with S in the diagram of FIG. 2b the trend of the spring characteristic thus changes progressively. The spring hardness, increased in this manner, prevents a further retraction of the downhill cylinders, such as cylinders 2 of FIG. 2a, so that an increased tilt angle of the machine is prevented despite its location on a slope.

If, when travelling on a slope with an even greater slope angle, an even greater increase of force occurs, resulting in an inadmissibly long retraction stroke and thus a danger of overturning, the second valves 32 and 34 are additionally switched into the closed position. In this state, as shown in FIGS. 3a and 3b, only the accumulator volumes of the accumulators 28 and 30 remain in the system. In this switching state, which produces the greatest spring hardness as shown by the trend of the characteristic in FIG. 3b, a further retraction movement could only occur in the instance of an extreme load increase. Thus the machine is also protected against overturning in case of travel on a steep slope.

The hard state of the suspension is also suitable when the machine travels on a road where no load shift signal is generated by the roll stabilization system. For the purpose of arbitrarily selecting a hard suspension for road travel, the operator or driver of the machine is provided with a facility to enter control signals for the switching device. Thus, the operator is also able to arbitrarily set the suspension system into the soft state (FIG. 1a) or to medium hardness (FIG. 2a). The simplified representation of the circuits in FIGS. 1a, 2a and 3a not only omits the level control valves for the roll stabilization system, but also the usual facilities provided for the pressure protection of the fluid connections 12, 14 to tank 42.

1. A mobile machine, in particular an agricultural machine such as a self-propelled spray unit, comprising a structure that is hydraulically supported with respect to an undercarriage by means of cylinders (2, 4) that are provided with a piston chamber (6) and a rod chamber (8), wherein a switching device (18, 22, 36, 38) is provided that connects, in one switch position, the piston chamber (6) of one cylinder (2, 4) with the rod chamber (8) of another cylinder (2, 4) and vice versa in a fluid-conducting manner, characterized in that first (18, 22) and second valves (36, 38) are connected to the respective fluid connections (12, 14) between the piston chamber (6) of the one cylinder (2, 4) and the rod chamber (8) of the other cylinder (2, 4) as part of the switching device, wherein said first valves (18, 22) are each connected to the inlet side of the piston chamber (6) and to a first hydraulic accumulator (28, 30) each, and the said second valves (36, 38) are each connected to the inlet side of the rod chamber (8) and at the outlet side to a second hydraulic accumulator (32, 34) each.

2. The machine according to claim 1, characterized in that valves (18, 22, 36, 38) are provided in form of 2/2-way switching valves.

3. The machine according to claim 1, characterized in that valves (18, 22, 36, 38) may be operated electromagnetically.

4. The machine according to claim 1, characterized in that valves (18, 22, 36, 38) are mechanically preloaded into the closed position.

5. The machine according to claim 1, characterized in that the rod chamber (8) of the cylinders (2, 4) is connected to a suction device which is provided with a non-return valve (40) that blocks in the direction of a tank (42) that stores fluid.

6. The machine according to claim 1, characterized in that the cylinders (2, 4), which are connected to each other in a fluid-conducting manner (12, 14), are assigned to the each other opposing wheels of a common axle.

7. A method for the stable operation of a mobile machine according to claim 1, which is provided with a roll stabilizing system, characterized in that, depending on travelling tasks as well as the signals generated by the roll stabilizer, which represent the state of loading of the cylinders (2, 4), the first (18, 22) and the second valves (36, 38) are operated in groups each into a switch position that is the same for the respective group.

8. The method according to claim 7, characterized in that the operation of the valves (18, 22, 36, 38) is based upon the terrain-dependent travelling tasks of the machine.

9. The method according to claim 7, characterized in that, when travelling on a field compared to travelling on the road, a softer suspension can be provided by the cylinders (2, 4) in that the valves (18, 22) of the first group and the valves (36, 38) of the second group are all switched into the open state.

10. The method according to claim 7, characterized in that, for travelling on a slope, the valve group (36, 38) that is assigned to the cylinders (2, 4) of the downhill wheels are actuated into the open position, and the valves (18, 22) of the other group are actuated into the closed position.

11. The method according to claim 7, characterized in that, when travelling on a steep slope the valves (18, 22, 36, 38) of all groups are switched into the closed position.
